(19) United States
(12) Patent Application Publication
(10) Pub. No.: US 2022/0186698 A1
(43) Pub. Date: Jun. 16, 2022

(54) INJECTOR UNIT FOR THE INJECTION OF FUEL, AND METHOD FOR THE OPERATION OF AN INJECTOR UNIT OF THIS TYPE

(71) Applicant: LIEBHERR-COMPONENTS DEGGENDORF GMBH, Deggendort (DE)

(72) Inventors: Richard PIRKL, Regensburg (DE); Razvan-Sorin STINGHE, Hengersberg (DE); Martin SEIDL, Deggendorf (DE)

(21) Appl. No.: 17/427,898

(22) PCT Filed: Feb. 11, 2020
(86) PCT No.: PCT/EP2020/053395

§ 371 Date: Feb. 28, 2022

(30) Foreign Application Priority Data
Feb. 11, 2019 (DE) 10 2019 103 362.4

(51) Int. Cl. F02M 63/00; F02D 41/20; F02M 47/02

(52) U.S. Cl. CPC F02M 63/0017; F02D 41/20; F02M 47/027; F02D 2041/2058; F02D 2041/2024; F02D 2041/2037; F02M 63/0075

(57) ABSTRACT

The injector unit according to the disclosure comprises a seat plate with a through opening extending through the seat plate, an armature element which can be placed onto the seat plate, in order to close the through opening, a spring element pushing the armature element in the direction of the seat plate, in order to close the through opening, an electromagnet designed to load the armature element with a force, in order to lift the armature element from the seat plate, and a stop for limiting a stroke of the armature element in a state in which it is lifted from the seat plate. The injector unit is characterized by a control unit designed to reduce an actuating signal of the electromagnet for lifting the armature element from the seat plate before the armature element contacts the stop for the first time after being lifted from the seat plate.

### TECHNICAL FIELD

The present disclosure relates to an injector unit for injecting fuel and to a method of operating same.

### BACKGROUND AND SUMMARY

In internal combustion engines such as diesel engines or also gasoline engines a fuel is as a rule injected via an injector into a combustion chamber in a specific quantity and for a specific time period. It is necessary in this process due to the very short injection times that are in the microsecond range to open or close the outlet opening of the injector with a very high frequency.

Since the basic functional principle of an injector is familiar to the skilled person, some aspects that are of advantage for the understanding of the disclosure will only be looked at briefly in the following.

An injector typically has a nozzle needle (also: injector needle) that allows a highly pressurized fuel to exit outwardly on release of at least one discharge hole of the injector. This nozzle needle acts in cooperation with this at least one discharge opening as a plug that enables a discharge of the fuel when raised. It is therefore accordingly necessary to raise this needle at relatively short time intervals and to allow it to slide back into the outlet opening after a brief period. In this respect, hydraulic servo valves can be used that control the triggering of this movement. Such valves are in turn controlled with the aid of an electromagnet.

Due to the high injection pressures of up to 2500 bar, it is not possible to control or to move the jet needle directly with the aid of a magnetic valve. The required forces for opening and closing the jet needle would be too great here so that such a process would only be able to be implemented with the aid of very large electromagnets. Such a design is, however, excluded due to the only limited available installation space in an engine.

So-called servo valves that control the jet needle and are themselves controlled via an electromagnetic valve are typically used instead of the direct control. In this respect, a pressure level that acts on the jet needle in the closure direction is built up in a control space interacting with the jet needle with the aid of the available highly pressurized fuel. This control space is typically connected to the high pressure region of the fuel via a feed line. This control space (also: lower control space) further has a line to a valve space (also: upper control space) that has a closable outflow throttle (also passage opening) from which the highly pressurized fuel on the one side of a seat plate can escape toward a low pressure region on the other side of the seat plate. The term seat plate is used here in the sense of a throttle plate or of a sealing plate. When it does this, the pressure in the valve space and in the control space falls, whereby the closure force acting on the jet needle is reduced since the high pressure fuel of the valve space and of the control space can flow off. A movement of the jet needle is thereby produced that releases the outlet opening at the injector tip. To be able to control the movement of the jet needle, the outflow throttle in the seat plate of the injector is selectively opened or closed with the aid of an armature element.

The armature element that closes or releases the passage opening of the seat plate is actuated with the aid of an electromagnet. If the electromagnet is in a deenergized state, a certain spring force is required that presses the armature element toward the passage opening (=opening in the seat plate). In an energized state of the electromagnet the armature element is drawn against the spring force exerted by the spring element so that a compression of the spring occurs and the armature element is raised from the passage opening and releases it.

As already briefly explained, the high pressure fuel therefore flows via the passage opening of the seat plate into a low pressure region. There is thereby not only a pressure drop in the valve space, but—due to the line connecting the valve space and the control space—also in the control space adjacent to the nozzle needle. The pressure reduction in the control space has the result of raising the jet needle out of its nozzle seat and of outputting fuel from the injector.

It is problematic with the above-described process for releasing the passage opening that the armature element abuts an abutment and impinges it on the opening due to the applied magnetic force. This so-called armature bounce at the abutment that bounds the stroke of the armature element has the result that the release of the nozzle needle from its nozzle needle seat and thus the release of squirt openings is subject to a certain time variation. Only a certain time range in which the nozzle needle will move out of its seat therefore has to be predicted on an injection procedure. As a result, this time variation leads to the injection amount regulation being designed as relatively conservative, which results in increased fuel consumption.

The armature bounce additionally produces wear of the armature and of the abutment abutting it, which can result in a premature replacement of one of the two components.

The armature bounce not least additionally results in a heat production of the mutually abutting parts that requires a certain thermal design of the components and, under certain circumstances, even requires a concept for dissipating the thermal heat.

It is the aim of the present disclosure to provide an injector unit for injecting fuel that at least partially overcomes or alleviates the aforesaid disadvantages. This is done with the aid of the injector unit.

In accordance with the disclosure, the injector unit for injecting fuel comprises a seat plate having a passage opening that extends through the seat plate, an armature element that can be placed onto the seat plate to close the passage opening, a spring element that urges the armature element in the direction of the seat plate to close the passage opening, an electromagnet that is configured to exert a force on the armature element to raise the armature element from the seat plate, and an abutment for bounding a stroke of the armature element in a state raised from the seat plate. The injector unit is characterized by a control unit that is configured to reduce a control signal of the electromagnet to raise the armature element from the seat plate before the armature element contacts the abutment for the first time after a raising from the seat plate.

Provision can be made here that the control signal is the current signal that flows through a coil of the electromagnet.

Provision can furthermore be made that the passage opening connects the two planar sides of the seat plate with one another and the armature placed on the seat plate hydraulically seals the passage opening. The passage opening can furthermore be an outflow throttle that connects a space arranged below the seat plate to a space arranged above the seat plate.

The feature that goes beyond the prior art and that is due to the specific shape of the control signal of the electromagnet has the effect that the armature bounce that normally occurs is greatly reduced or no longer occurs at all. This is because the control signal for the exertion of the magnetic force of the electromagnet is then already reduced even though the armature element is still not in its desired end position. The speed and thus the force at which the armature element impinges its abutment bounding the stroke is thereby reduced so that the disadvantages associated with the armature bounce can be alleviated.

To raise the armature element from its position sealing the passage opening, the magnetic force acting on it first has to overcome the spring force acting in the opposite direction and any friction forces. As the movement continues, the attractive magnetic force increases constantly as the distance between the armature element and the magnet decreases and the armature element is increasingly accelerated until the armature element is abruptly braked by the abutment.

Provision is made in accordance with the disclosure that the control unit is configured to at least once interrupt or reduce the control signal during the attraction of the armature in the direction of the magnet. The attractive magnetic force is reduced very much at times by the interruption or reduction of the control signal. The interruption or reduction takes place such that the armature subsequently continues to move due to the forces acting on it such that it impinges on the abutment at a speed of zero or at least at a very low speed. The bounce is thereby completely prevented or at least very much reduced.

Provision is made in accordance with a further modification of the disclosure that the control unit is configured to reduce the control signal of the electromagnet by more than 50%, or by more than 75%, or by more than 90%, from a starting value at the start of the raising procedure.

Provision can furthermore also be made that the control unit is configured to raise the control signal again after a reduction of the control signal of the electromagnet, such as to a range of at least 50%, or of at least 75%, or of at least 90%, of a starting value.

The control signal that controls the magnetic attraction of the armature element controls can thus only drop greatly for a brief moment and can again move to or close to the starting level shortly afterward. This brief decline of the control signal has the effect that the armature is moved away from the passage opening despite the brief decline of the constant signal. In this respect, the brief drop of the control signal can be dimensioned such that no temporary approach of the armature element in the direction of the passage opening occurs after the raising of the armature element from the passage opening. The speed of the armature element can admittedly fall down to a standstill of the armature element on the way from the passage opening to the stroke-bounding abutment, but there may be no approach of the armature element in the direction of the passage opening in this process.

It is ensured by the control signal that is configured in this manner that the unwanted armature bounce at the abutment is reduced and a particularly exact injection amount regulation of the injector is achieved.

Provision can be made in accordance with a further development of the disclosure that the control unit is configured to raise the control signal of the electromagnet again once the armature element has contacted the abutment for a first time after a raising from the seat plate and/or when the stroke of the armature element has reached a reversal point or is close to the reversal point in time.

A point in time for the raising of the control signal from the reduced level can thus be selected in dependence on a position of the armature element. It would make sense here to increase the control signal of the electromagnet once the armature element has contacted the abutment for a first time after a raising from the seat plate and/or when the stroke of the armature element has reached a reversal point. There is otherwise an unwanted movement of the armature element in the direction of the sealing opening.

Provision can be made in accordance with the disclosure that the control unit is configured to transmit the control signal in a binary manner, that is only to transmit the control signal states On and Off. It may be useful for the configuration and control of the unit in accordance with the disclosure for the control signal only to be able to adopt two states, namely On and Off.

The control signal is then deactivated or temporarily deactivated after an On period during a raising procedure of the armature element. This produces a raising procedure that is more useful overall and that has a smaller armature bounce.

Provision can be made that the seat plate is configured in a closed state of the passage throttle to separate a low pressure region and a high pressure region of the fuel.

Provision can be made in accordance with a further modification of the disclosure that the space that is provided for the carrying out of the stroke of the armature element is filled with a fluid, such as the fuel. The fluid here is not magnetizable or is only weakly magnetizable.

An armature guide can furthermore be provided to guide the armature element on a stroke procedure, said armature guide may extend from the seat plate in the direction of the abutment. This guide serves the targeted placement or raising of the armature element from the passage opening of the seat plate.

Provision can be made in accordance with the disclosure that the electromagnet has a magnetic core and a coil that partially or completely receives the magnetic core.

The abutment can be a front surface of the electromagnet or also a front surface of a magnetic core of the electromagnet. However, the case is also covered by the disclosure that the abutment is not a part of the electromagnet.

The abutment may, however, be provided in the interior of the spring element configured as a spiral spring so that the spiral spring winds around the abutment.

The disclosure moreover relates to a method of operating an injector unit for injecting fuel that can be designed in accordance with one of the preceding variants, with an armature element being raised in the method from a seat plate against a spring force exerted by a spring in the direction of the seat plate by means of an electromagnet to release a passage opening of the seat plate. The method is characterized in that the control signal of the electromagnet, that effects a raising of the armature element from the seat plate, is reduced before the armature element contacts an abutment that bounds the stroke of the armature element for the first time after a raising from the seat plate.

The method can be further developed in that the control signal of the electromagnet is reduced by more than 50%, or by more than 75%, or by more than 90%, from a starting value at the start of the raising procedure.

Provision can furthermore be made that the control signal is raised again after a reduction of the control signal of the electromagnet, such as to a range of at least 50%, or of at least 75%, or of at least 90%, of a starting value at the start of the raising procedure.

Provision can be made there that the control signal of the electromagnet is raised again once the armature element has contacted the abutment for a first time after a raising from the seat plate and/or when the stroke of the armature element has reached a reversal point or is close to a reversal point.

The method in accordance with the disclosure can moreover provide that the control signal is of a binary nature, that is only the control signal states On and Off are transmitted to the electromagnet.

### BRIEF DESCRIPTION OF THE FIGURES

Further details and features of the disclosure will become apparent with reference to the following description of the Figures. There are shown:

FIG. 1: a diagram for the illustration of the control signal in accordance with the disclosure with respect to the prior art; and

FIG. 2: an enlarged detail of a partial sectional view around the seat plate of a fuel injector.

### DETAILED DESCRIPTION

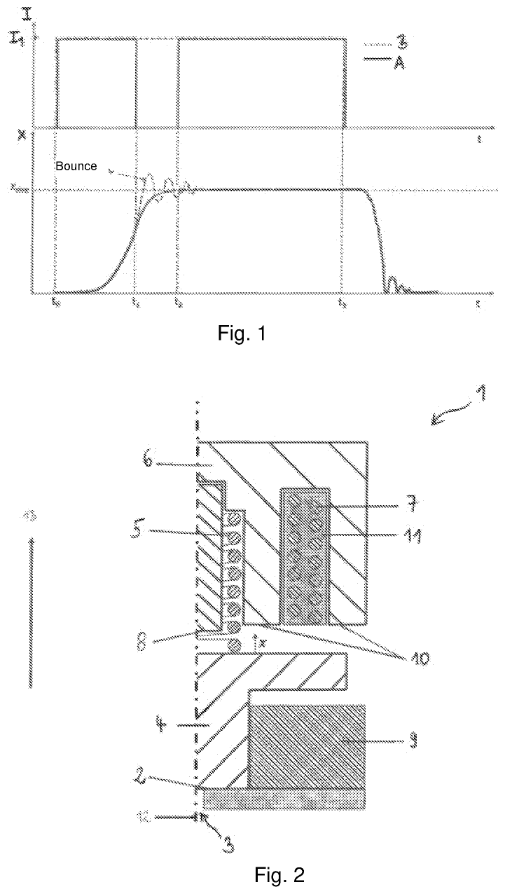

FIG. 1 shows two diagrams arranged above one another over the time t, with the upper one of the two diagrams showing the curve of a control signal I, or of the current supplied to the electromagnet in accordance with the disclosure (solid line A), and in accordance with the prior art (dashed line B). The diagram arranged therebelow shows the movement (x) of the armature element in dependence on the different control signals, with the dashed line representing the control behavior in accordance with the prior art and the continuous line showing the control in accordance with the disclosure.

It can be seen from the diagrams that the armature element lies on the seat plate at the time to so that the passage opening is sealed.

If now at the time to the current signal I for controlling the electromagnet is set to a value I₁ that is different from zero and that has the result that the armature element is moved from the seat plate in the direction of a stroke-bounding abutment, the armature element first moves slowly and then at an ever faster speed in the direction of the abutment (cf. dashed line B). The attractive magnetic force increases constantly here as the distance between the armature and the electromagnet decreases and the armature element is increasingly accelerated until the armature element is abruptly braked by an abutment (Xₛₜₒₚ). There is subsequently a pronounced bounce behavior of the armature at the abutment. The bounce has a negative effect on the settability of the magnetic valve and on the feedback on the hydraulic switching behavior and increases the wear at the magnet and at the armature element.

On the termination of the bounce, the armature element remains at its abutment in the position remote from the passage opening until the control signal I₁ is switched off at the time t₀. The current flow through the coil is then completely depleted and the magnetic field degenerates, with some of the magnetic field being maintained for a brief time due to remanence effects and eddy current influences. As soon as the abating magnetic force no longer overcomes the spring force, the armature is urged back onto the seat plate by the spring.

The bounce at the maximum deflection of the armature element at the distance Xₛₜₒₚ is problematic here.

The bounce of the armature at the abutment Xₛₜₒₚ spaced apart from the seat plate should be prevented or at least greatly reduced with an improved control signal in accordance with the disclosure. Provision is made in accordance with the disclosure to interrupt or reduce the control signal at least once during the attraction of the armature in the direction of the abutment or of the magnet.

After the current signal I for controlling the electromagnet has been set to the value I₁ at the time to—exactly as in accordance with the prior art—the armature element starts to move from the seat plate in the direction of the abutment.

Provision is, however, now made in accordance with the disclosure to already reduce the control signal, or to reset it to zero as shown in FIG. 1, before a contact of the armature element with the abutment. The attractive magnetic force is hereby reduced so much at times that the armature subsequently continues to move due to the forces acting on it such that it impinges on the upper abutment at a speed of zero or at least at a very low speed. The bounce is thereby completely prevented or at least very much reduced.

In the ideal case, the control signal is activated again (last control signal activation at the time t₂) as soon as the armature impinges on the second abutment at a speed of zero or close to zero so that the armature is held in abutment until the control signal is finally ended (time t₃). The case is, however, also covered by the disclosure according to which the armature either does not reach the abutment or reaches it at a speed greater than zero. The control signal is then activated again in a time range in which the armature speed is closed to zero (time t₃). The bounce can, however, not be completely suppressed, but is significantly reduced in comparison with the conventional control.

If it is no longer desired that the armature element releases the passage opening of the seat plate, the control signal is deactivated at the time t₃, whereby the armature element is urged by the spring element in the direction of the seat plate and impinges there—in a similar manner as at the abutment spaced apart from the seat plate on an energizing of the electromagnet in accordance with the prior art.

FIG. 2 shows an enlarged detail of a partial sectional view around the seat plate 2 of a fuel injector 1.

The representation is only shown on one side of the symmetrical axis 12. It can be recognized at the lower end of the representation that the seat plate 2 has a (centrally arranged) passage opening 3 that can be closed by the placing on of an armature element 4. The armature element 4 is here guided in an armature guide 9 that permits a targeted movement of the armature element 4. A spring element 5, typically in the form of a spiral spring, that urges the armature element 4 in the direction of the seat plate 2 is provided above the armature element 4, that is at the side of the armature element 4 remote from the seat plate 2. The spring element 5 is here automatically supported at an electromagnet 6, 7 and receives an abutment 8 that bounds the stroke movement (indicated by x) of the armature element 4 in the interior of its windings. The front side 10 of the electromagnet 6, 7 facing the armature element 4 can, however, also serve as an abutment in accordance with a variant of the disclosure. There can also be recognized by the reference numeral 11 a coil jacketing of the coil 7 that is arranged in a cutout of the magnet core 6. Reference numeral 13 furthermore shows the axial direction of the injector.

The symmetrical axis 12 here shows the substantially pivotably symmetrical or rotationally symmetrical basic design of the injector.

1. An injector unit for injecting fuel comprising:
a seat plate having a passage opening that extends through the seat plate;
an armature element that is placeable onto the seat plate to close the passage opening;
a spring element that urges the armature element in the direction of the seat plate to close the passage opening;
an electromagnet that is configured to apply a force onto the armature element to raise the armature element from the seat plate; and
an abutment for bounding a stroke of the armature element in a state raised from the seat plate,
wherein
a control unit that is configured to reduce a control signal of the electromagnet to raise the armature element from the seat plate before the armature element contacts the abutment for the first time after a raising from the seat plate.

2. The injector unit in accordance with claim 1, wherein the control unit is configured to reduce the control signal of the electromagnet by more than 50% from a starting value at the start of the raising procedure.

3. The injector unit in accordance with claim 2, wherein the control unit is configured to raise the control signal again after a reduction of the control signal of the electromagnet of a starting value at the start of the raising procedure.

4. The injector unit in accordance with claim 3, wherein the control unit is configured to raise the control signal of the electromagnet again
once the armature element has contacted the abutment for the first time after a raising from the seat plate; and/or
when the stroke of the armature element reaches a reversal point or is close thereto in time.

5. The injector unit in accordance with claim 3, wherein the control unit is configured to transmit the control signal in a binary manner, that is only to transmit the control signal states On and Off.

6. The injector unit in accordance with claim 3, wherein the seat plate is configured in a closed state of the passage throttle to separate a low pressure region and a high pressure region of the fuel.

7. The injector unit in accordance with claim 3, wherein the space that is provided for the carrying out of the stroke of the armature element is filled with a fluid.

8. The injector unit in accordance with claim 3, wherein an armature guide is furthermore provided to guide the armature element on a stroke procedure, said armature guide.

9. The injector unit in accordance with claim 3, wherein the electromagnet has a magnetic core and a coil that partially or completely receives the magnetic core.

10. The injector unit in accordance with claim 3, wherein the abutment is a front surface of the electromagnet.

11. A method of operating an injector unit for injecting fuel wherein, in the method,
an armature element is raised from a seat plate against a spring force exerted by a spring element in the direction of the seat plate by means of an electromagnet to release a passage opening of the seat plate,
wherein
the control signal of the electromagnet, that effects a raising of the armature element from the seat plate, is reduced before the armature element contacts an abutment that bounds the stroke of the armature element for the first time after a raising from the seat plate.

12. The method in accordance with claim 11, wherein the control signal of the electromagnet is reduced by more than 50%, from a starting value at the start of the raising procedure.

13. The method in accordance with claim 3, wherein the control signal is raised again after a reduction of the control signal of the electromagnet to a range of at least 50% of a starting value at the start of the raising procedure.

14. The method in accordance with claim 13, wherein the control signal of the electromagnet is raised again
once the armature element has contacted the abutment for the first time after a raising from the seat plate; and/or
when the stroke of the armature element reaches a reversal point or is close thereto.

15. The method in accordance with claim 3, wherein the control signal is of a binary nature, that is only the control signal states On and Off are transmitted to the electromagnet.

16. The injector unit in accordance with claim 2, wherein the control unit is configured to reduce the control signal of the electromagnet by more than 90%, from a starting value at the start of the raising procedure.

17. The injector unit in accordance with claim 3, wherein the control unit is configured to raise the control signal again after a reduction of the control signal of the electromagnet to a range of at least 90%, of a starting value at the start of the raising procedure.

18. The injector unit in accordance with claim 7, wherein the space that is provided for the carrying out of the stroke of the armature element is filled with the fuel.

19. The injector unit in accordance with claim 8, wherein the armature guide extends from the seat plate in the direction of the abutment.

20. The injector unit in accordance with claim 10, wherein the abutment is a front surface of a magnetic core of the electromagnet.
